(19) United States
(12) Patent Application Publication
(10) Pub. No.: US 2017/0025022 A1
(43) Pub. Date: Jan. 26, 2017

(54) Process to Enable Prioritization of Air Space in an Environment with Unmanned Aerial Vehicles

(71) Applicants: Donald Putnam Henry, Menlo Park, CA (US); Charles Marshall, Atherton, CA (US)

(72) Inventors: Donald Putnam Henry, Menlo Park, CA (US); Charles Marshall, Atherton, CA (US)

(73) Assignee: AerWaze, East Palo Alto, CA (US)

(21) Appl. No.: 15/077,652

(22) Filed: Mar. 22, 2016

Related U.S. Application Data
(60) Provisional application No. 62/137,150, filed on Mar. 23, 2015.

(51) Int. Cl. G08G 5/00; B64C 39/02; H04W 4/12

(52) U.S. Cl. CPC G08G 5/0095; H04W 4/12; B64C 39/024; H04W 4/02

(57) ABSTRACT

Flight safety and air vehicle deconfliction are of paramount concern in the operation of manned aircraft. The introduction of unmanned aerial vehicles (UAVs) in quickly growing numbers raises the risks of mid-air collisions, near misses, and diversions from intended flight paths. This application discloses a series of linked process whereby such risks may be significantly reduced and may enable the safe integration of UAVs into the national airspaces of the United States and other nations. The disclosed process allows emergency responders and others to declare an emergency air operations zone (perhaps near the expected landing spot of a medivac helicopter) and notify UAV operators in the vicinity of that zone of the emergency and suggested or mandated actions for the UAV operators to take (i.e., land your airframe as soon as possible, do not approach this spot, be alert for emergency aircraft, etc.). The emergency or priority zone would be limited in location and time. The notifications are made to UAV operators either through an application running on a mobile phone or other connected device or by calls, texts, or other alerts to such devices. The process has uses beyond providing priority to emergency services. For example, a city could provide priority airspace to a film crew using UAVs and notify other UAV users to keep clear of a particular area for a limited time.

### CROSS REFERENCE TO RELATED APPLICATIONS

The present application relates to and claims priority of U.S. provisional patent application (“Copending Provisional Application”), Ser. No. 62/137,150, entitled “A PROCESS TO ENABLE PRIORITIZATION OF AIR SPACE IN AN ENVIRONMENT WITH UNMANNED AERIAL VEHICLES,” filed on Mar. 23, 2015. The disclosure of the Copending Provisional Application is hereby incorporated by reference in its entirety.

### BACKGROUND OF THE INVENTION

1. Field of Invention:

Flight safety and air vehicle deconfliction are of paramount concern in the operation of manned aircraft. The introduction of unmanned aerial vehicles (UAVs)¹ in quickly growing numbers raises the risks of mid-air collisions, near misses, and diversions from intended flight paths. This application discloses a series of linked process whereby such risks may be significantly reduced and may enable the safe integration of UAVs into the national airspace of the United States and other nations. ¹ The Federal Aviation System uses the term Unmanned Aerial System or UAS. We use the more common term here of Unmanned Aerial Vehicle or UAV. For our purposes, the two terms are interchangeable.

2. Discussion of the Related Art

For year, the Federal Aviation Administration (FAA) has administered a system of flight safety that deconflicts aircraft through three integrated elements. Near congested airports and other airspace, the FAA maintains air traffic control (ATC) radars which provide a two dimensional picture of the aircraft in the area. Most aircraft carry transponders-devices which, when illuminated by radar signals from the ATC radars, emit a signal which provides the identification of the airframe and its altitude. The ATC radars together with the transponder signals provide FAA air traffic controllers a three-dimensional picture of the relevant airspace and these controllers communicate with the aircraft in that airspace to direct them to safe flight paths.

This current system may well prove inadequate for the emerging national airspace which will increasingly include UAVs. Congress has mandated that the FAA “provide for the safe integration of civil unmanned aircraft systems into the national airspace system as soon as practicable, but not later than Sep. 30, 2015.”² The existing ATC system may prove inadequate for this mandate for several reasons: ² 49 USC 40101 Section 332(3)
Most UAVs currently do not carry transponders.
Most UAV flights are below the radar horizon of ATC radars so transponders would be ineffective even if required.
The number of UAVs, even if equipped with transponders and operators equipped with radios, might quickly overwhelm the capacity of the current ATC system.
UAV operators currently rarely carry equipment to receive and respond to communications from air traffic controllers.
UAV operators are often trained to a lower level than licensed pilots and thus may have difficulty following directions from air traffic controllers.

Among the most serious issues arising from the increase in UAVs is the interference with other aircraft. UAVs operating near and even over runways of major airports are a significant problem. Such incidents occur when UAV operators ignore current FAA regulations which require permission from an airport operator and control tower when flying within 5 miles of an airfield. Similarly, flights over major sporting events and crowded areas are forbidden. While a combination of education and enforcement may solve these issues, there are instances when a particular airspace needs to be cleared of UAVs (such as the landing of a medevac helicopter at an accident scene). There is no current provision for notifying UAV operators, flying their airframes and complying with all laws and regulations, of emergencies of limited location and time.

### SUMMARY OF THE INVENTION

This application discloses a set of linked processes to help improve safety and deconflict aerial vehicles. The process links a central server through which emergency services personnel and others authorized by law can request priority airspace in a limited geographic area for a limited time. UAV operators would volunteer to or be required to have a mobile device with them while operating UAVs. The mobile device could be a smart phone, other connected devices such as a tablet, or built into or programmed onto the control system used by a UAV operator to control his or her airframe if such control system is more widely connected. The device would execute a program while the UAV was aloft, and that device would periodically notify the central server of its location (or the location of the UAV if accessible to the device and code) and provide a pathway through which to send emergency notifications. When the emergency services (or other authorized) personnel declare an emergency through the system, the central server sends an alert to all devices with application or code executing which are located within or near that particular geographic area (or UAVs in or near that area if devices providing UAV location). While the disclosed process could be linked to or integrated with the current ATC control system, it will also work as a stand-alone alert system for UAVs.

### BRIEF DESCRIPTION OF THE DRAWINGS

FIG. 1 provides an overview of the process

FIG. 2 shows the communications pathways and data flows of the process

FIG. 3 shows a possible 2-way confirmation version of the process

FIG. 4 shows an illustrative example of an emergency air operations area

FIG. 5 shows alternative uses of the process

### DETAILED DESCRIPTION OF THE PREFERRED EMBODIMENTS

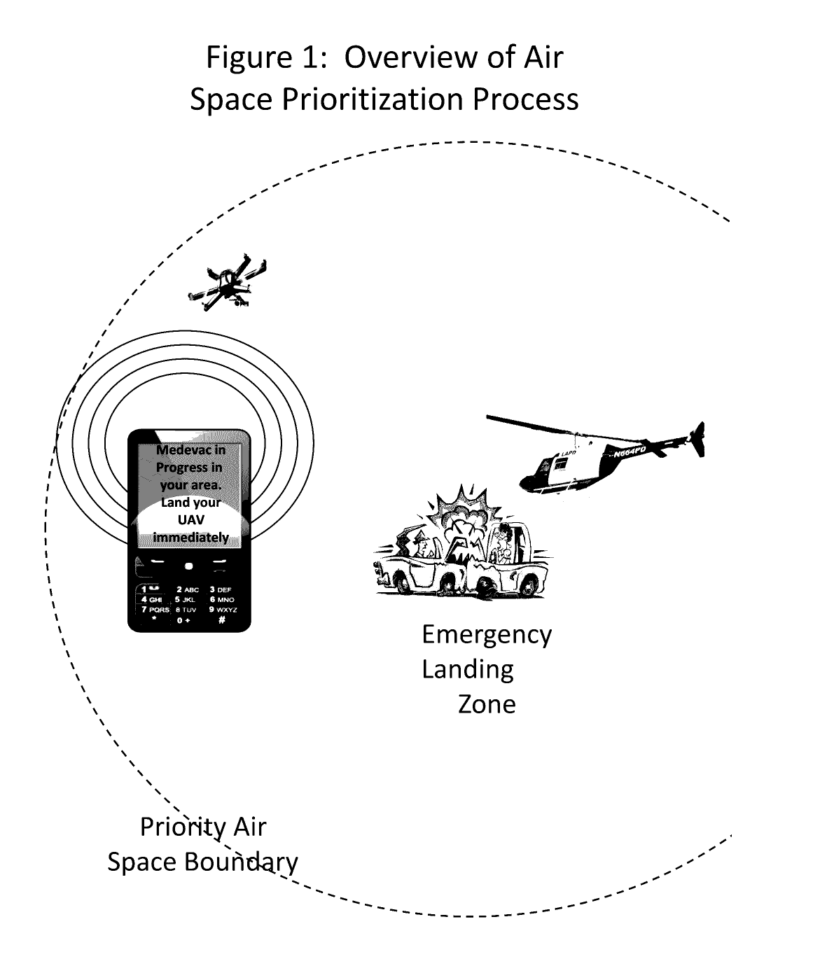

The disclosed process connects emergency service (or other authorized) personnel who wish to temporarily restrict UAV flights in a limited geographical area to dispersed UAV operators within or near that area. The emergency service personnel (or others) provide information about the desired restricted airspace to a central server. This information could be provided through a web portal (accessible through the internet from a computer or mobile device) or called in to personnel maintaining the central server to enter on behalf of the emergency services personnel (or others). The information from these personnel needs to be provided to dispersed UAV operators. (See FIG. 1 for an overview of process.)

This is accomplished by each UAV operator carrying a device connected to the central server through the internet or another communications pathway. Executable code on that each device, which the operator runs while flying a UAV, regularly transmits its location (determined by GPS or other means) and a communications pathway to the central server. A version could have the device send the location of the UAV (if such information is available to the device) instead of its own location. The time stamped locations of devices and UAVs are stored on the central server.

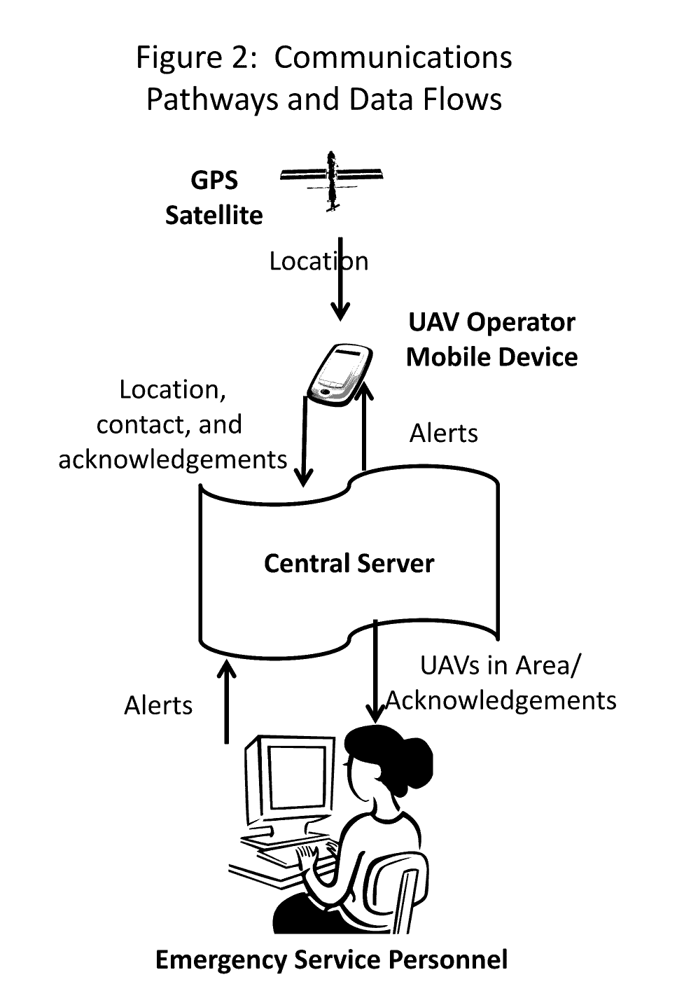

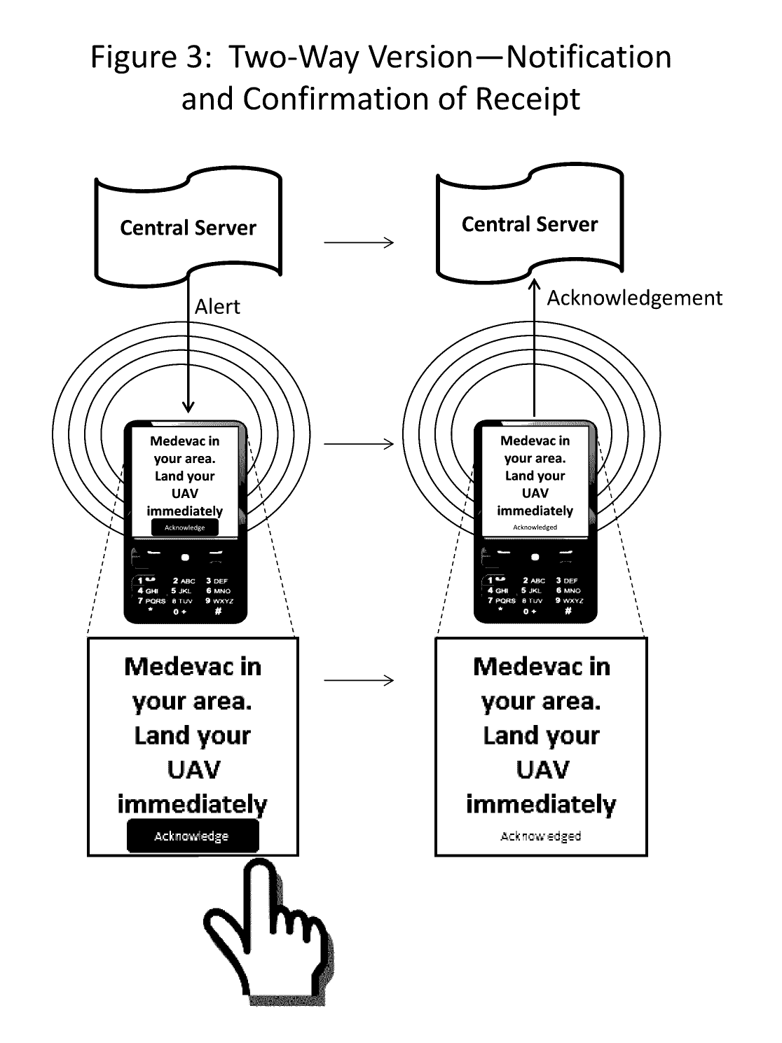

When an emergency service (or other authorized personnel) enter information (or have it entered for them) about an emergency situation requiring priority airspace, the location of that emergency is compared to the locations of devices of UAV operators executing the code (or locations of their UAVs). Those in or near the emergency zone are alerted. Such alerts might be as simple as a directive to land their UAVs as soon as possible or might include more detailed information such as the location of the incident that has created the need for the alert, the nature of the alert, and the expected duration of the priority airspace request. (See FIG. 2 for data flow and communications pathways.) The process may simply be one way—the alert is broadcast to the devices in a limited geographic area. Alternatively, it might be two ways—UAV operators who receive an alert may be asked to acknowledge receipt of the alert. (See FIG. 3.) The number (and perhaps locations) of the devices within the requested air space priority area might be made available to the requesting emergency personnel or agency or other interested parties. If a two way variant is used, the locations of those UAV operators who have not acknowledged the alert can also be displayed. Any alerts created in the system might be made visible to the Federal Aviation Administration, other governmental agencies, news organizations, or the public.

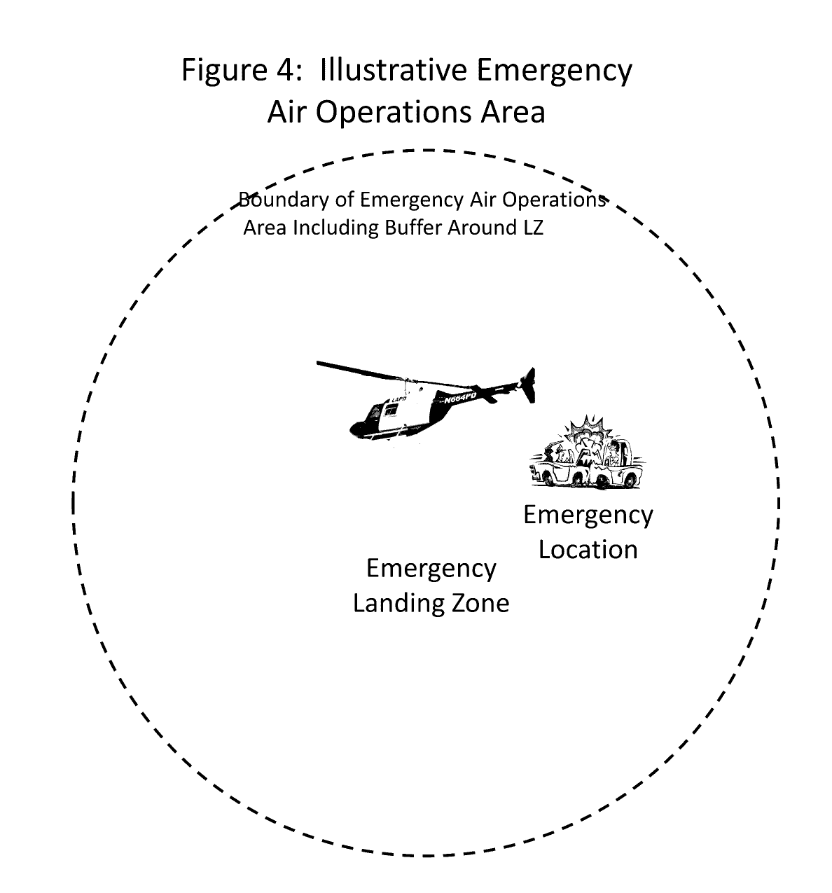

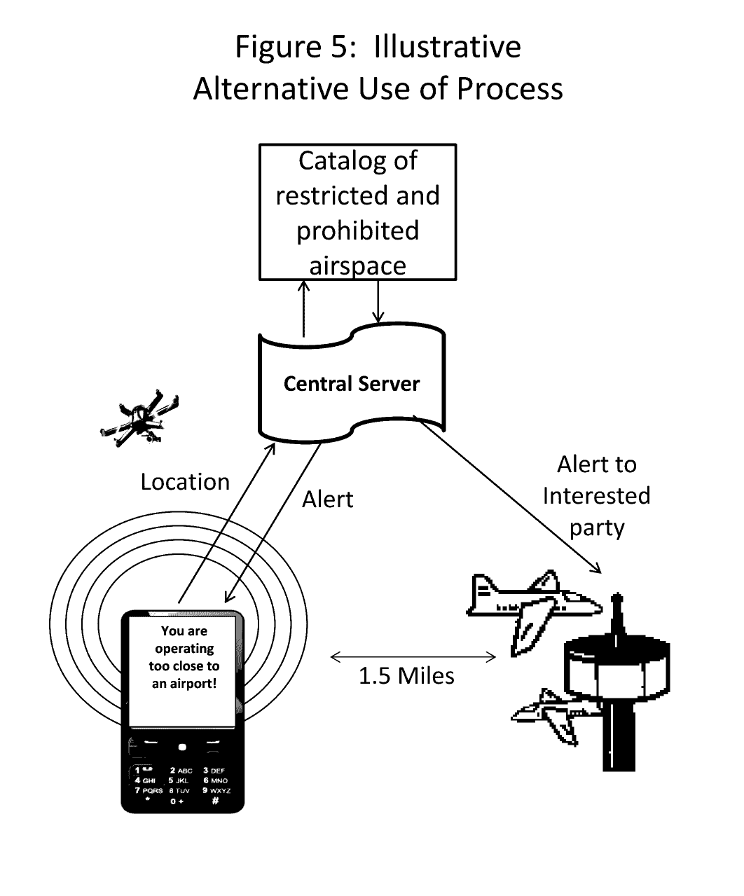

The requested emergency air operations area will likely be a circle centered on an expected landing zone. It could also be a flight path or a search area (for example when there is a search for a lost child, injured hiker, or fleeing criminal). (See FIG. 4.) The disclosure here could also be used for purposes other than for emergency responders. For example, it could be used to temporarily clear an area of drones for security reasons (visit by the President or other high-profile individual). It could also be used when a local or regional government wants to provide airspace free from interference or competing usage for such things as motion picture filming. The system could also be used to remind UAV operators of permanent restrictions (i.e., an operator activates system within 5 miles of an airfield) or time-dependent restrictions (such as operating near a sports or entertainment venue during an event). (See FIG. 5).

The process described here may have enhancements to ensure security, reduce the possibility of errors, and reduce the possibility of fraudulent signals being introduced. For example, an emergency services agency might only be allowed to issue alerts in or very near to locations it serves (including nearby areas where it has agreements to provide assistance). This would prevent, for example, an emergency agency in Boston from declaring an air emergency zone in San Diego (out of error, malice, or as an ill-considered practical joke). The signals to and from the mobile devices held by UAV operators could be encrypted to reduce the possibility of fraudulent signals being introduced into the system. Various levels of safeguards could be used to verify the identity and or authority of any person trying to request an emergency air operations zone. Such safeguards might be graduated requiring additional confirmation of longer times or for larger areas (for example, the Secret Service might be authorized to request an emergency air operations zone anywhere in the United States but would have additional verification steps to ensure the request is legitimate).

The process disclosed here can work either as a stand-alone alert system for UAV operations or as a supplement to the current ATC system. The current system could supplement guidance to pilots to avoid certain airspace with alerts sent through this process. The process also produces information of use to the current system. Any alerts entered by emergency services agencies could also be provided to ATC personnel. Any alerts of UAVs operating near airports or other restricted airspace could be similarly provided to ATC personnel.

What is claimed is:

1. A process whereby certain individuals or organizations can request or order a limited geographical area to be free of unmanned aerial vehicles (UAVs) or be for the exclusive use of that organizations (or designees UAVs) and such request or order is conveyed to operators of UAVs in or near that limited geographical area.

2. A specific embodiment of claim 1 whereby a central server receives requests or orders for restricting air space and conveys those requests to UAV operators within or near the affected area where these requests or orders might be permanent (i.e., prohibitions on operating a UAV in the vicinity of an airport without permission), predictable but temporary (i.e., flying a UAV in the vicinity of a major sporting event), or temporary and unpredictable (i.e., creating an emergency landing zone for a medevac helicopter at an accident site).

3. A specific embodiment of claim 2 whereby an application or other executable computer code is run on mobile devices including but not limited to mobile phones, tablets, or UAV controllers which periodically transmits its location and a communications pathway for return information or identification from which that pathway can be determined to a central server.

4. A variation of claim 3 whereby the device periodically transmits the location not of itself but of the UAV if such information is available to the device.

5. A refinement of claim 3 wherein the information sent from the device is encrypted or otherwise protected to enhance security of the locational and other data.

6. A further refinement of claim 5 wherein there is verification that the locational data is originating from a specific device which may or may not ne registered in advance to reduce the possibility that the locational and other data being transmitted from the devices to the central server is genuine rather than spoofed or otherwise fraudulently produced.

7. A specific embodiment of claim 2 whereby emergency services agencies and personnel, their designees, or others convey the need for an order of or request for temporarily restricted airspace to a centralized server either through an intern& access portal or contacting a call center which enters the order or request.

8. A specific embodiment of claim 2 whereby requests or orders for restricted airspace are compared to the locations of provided by devices, either the devices' own locations or the locations of corresponding UAVs and sends alerts to those devices.

9. A refinement of claim 8 wherein the signal from the server to the device is encrypted or otherwise protected to ensure that such signals are genuine rather than spoofed or otherwise fraudulently produced.

10. A further embodiment of claim 8 wherein the user of each device notified by the central server is asked to acknowledge receipt of the notification and provides a simple method of acknowledging such receipt which is conveyed back to the central server.

11. A refinement of claim 8 in which the personnel or organization requesting or ordering priority air space or other interested parties are informed when a device running the app is located in or near an area of restricted or prohibited air space.

12. A refinement of claim 11 in which notified personnel or organizations receive additional data which may include the number of devices running the app in or near the area, the approximate location of each device, and whether or not the UAV operator with the device has acknowledged alerts sent to him or her.

13. A refinement of claim 2 wherein some or all individuals or organizations placing requests or orders for priority air space are limited in the geographic locations in which they can make these requests or orders by jurisdiction, mutual support agreement, other interest or other criteria.

14. A refinement of claim 2 wherein some or all individuals or organizations placing requests or orders for priority air space are limited in the time for those requests, either in duration or lead time based on the characteristics or verifiable needs of the requestor.
